(19) United States
(12) Patent Application Publication
(10) Pub. No.: US 2004/0250370 A1
(43) Pub. Date: Dec. 16, 2004

(54) Method and device for cleaning the air intake system of a vehicle

(75) Inventors: Richard Augustus, Wichita, KS (US); Harold E. Erwin, Augusta, KS (US); Dennis Rosson, Wichita, KS (US)

Correspondence Address: Marshall S. Honeyman, SHOOK, HARDY & BACON L.L.P., One Kansas City Place, 1200 Main Street, Kansas City, MO, 64105-2118, US

(73) Assignee: BG Products, Inc.

(21) Appl. No.: 10/722,302

(22) Filed: Nov. 25, 2003

Related U.S. Application Data
(60) Provisional application No. 60/478,582, filed on Jun. 13, 2003.

(51) Int. Cl. B08B 9/043; B08B 9/045

(52) U.S. Cl. 15/304

(57) ABSTRACT

Disclosed is a device and method for cleaning the air-intake system of an EGR-valve-equipped diesel engine. The EGR valve is removed and replaced with a vessel in which a pressure drop is created. The pressure drop creates sufficient vacuum so that cleaner may be administered into the air-intake duct of the vehicle. The vessel uses sizeable vanes to control the vacuum. The vanes also create turbulence which make the cleaner more effectively contacted with contaminants existing within the air intake system. An auger is also disclosed for cleaning out the inside surfaces of the air-intake duct so that contaminants are not allowed to crumble into the air intake system. Also disclosed is a cleaner which is particularly useful in cleaning diesel engines and may be used with the devices and methods described above.

### STATEMENT REGARDING FEDERALLY SPONSORED RESEARCH OR DEVELOPMENT

Not applicable.

### CROSS-REFERENCE TO RELATED APPLICATIONS

This application claims the benefit of U.S. Provisional Application No. 60/478,582, filed Jun. 13, 2003.

### BACKGROUND OF THE INVENTION

1. Field of the Invention

The present invention relates generally to the field of cleaning the engine systems of vehicles. More specifically, the present invention relates to a method of cleaning the air intake systems of vehicles—especially diesels. Even more specifically, the present invention relates to the use of reducing the pressure in a chamber to create a vacuum in accomplishing the cleaning process. Also part of the present invention is a specific formulation to be administered as the cleaner.

2. Description of the Related Art

Motor vehicle engines, both gasoline and diesel-powered, have three fundamental components that participate in the combustion process—an air intake duct, a combustion chamber (or chambers), and an exhaust duct. It used to be that both gasoline-powered and diesel engines would intake air (containing oxygen) in through the air intake system, and for gasoline engines, fuel would be mixed with the air prior to entering the combustion chamber. With respect to the traditional diesel engine, the air was typically injected into directly into the combustion chamber. For both systems, however, only fresh, uncombusted air would be present in the entire system upstream from the combustion chamber. After combustion, undesirable contaminating hydrocarbons (“soot”) would form as a by-product of combustion and cling to components in the combustion chamber and exhaust system. With respect to the combustion chamber, the intake and exhaust valves, piston head, and side walls would be undesirably lined with soot. With respect to the exhaust system, its components would also be covered.

In order to remove this soot, cleaners could be easily mixed with the fuel before it was introduced into the air intake duct. This worked for these systems because there was no need to introduce cleaner upstream from where it was introduced. This is because no soot was present in the systems upstream from the point of combustion, such as the air intake system.

Later, exhaust gas recirculation (“EGR”) were introduced into gasoline engines. An EGR system takes a portion of the combusted exhaust gas from the exhaust system, and loops this portion back into the air intake duct of the vehicle. Once reintroduced into the air intake duct, and mixed with fresh air, this portion of already combusted air serves to make the overall combustion process less environmentally harmful.

Though great for the environment, this recirculation process had one major practical disadvantage, in that it resulted in soot being recirculated along with the exhaust. This presented contaminating soot into the EGR valve and air intake system. These portions of the air intake system, were before the introduction of these EGR systems, completely virgin from soot. Now that soot was present upstream from the combustion chamber, however, new methods had to be developed to clean soot from these places. The prior art methods of simply cleaner with the fuel would not work. This is because, doing so, does not introduce the cleaner to contaminants in the EGR valve or other parts of the air intake system.

To overcome this obstacle, technicians used several different methods. Once such method involved simply spraying a cleaner into the air intake system to “decarb” at the point of air introduction. This procedure didn't work very well, because it didn't adequately clean the EGR valve (again, the point at which the recirculated air is introduced into the air intake system). To overcome this, technicians began spraying cleaners, either alternatively or additionally, into the EGR valve itself. These techniques were all dependent on the significant vacuum created by the combustion chambers in these gasoline engines. The vacuum created in a gasoline engine is much greater than that created in a diesel engine. Thus, it is sufficient to draw the cleaner through the EGR valve for cleaning purposes. These methods are still the most effective way to clean gasoline engines with EGR systems.

Recently, however, diesel engines are being manufactured with EGR components. This has created quite a dilemma for technicians wishing to adequately clean these new systems. This is because the combustion chambers in diesels create less vacuum than those in gasoline engines. Because of this, the prior art methods of simply spraying cleaner in through the EGR valve will not work because there is not enough vacuum to draw the cleaner in through the system. Thus, there is a need in the art, for a cleaning technique that would artificially create this necessary vacuum. Further, there is a need that additional turbulence be created which will assist with the circulation of the cleaner administered by vacuum. Also needed is a particular formulation which is specifically adapted for use in the cleaning of a diesel air intake which is EGR adapted.

Other cleaning-elated problems exist with these new systems, as well. In an air intake system using an EGR valve, it is usually necessary to clean the EGR valve by removing it. After its removal, significant deposits typically accumulate proximate the end of the air intake duct from which the EGR valve has been removed. Manually cleaning these deposits on the air intake duct has proven difficult. This is because scraping and/or scrubbing these deposits may result in them falling further within the air intake system. These chunks of hydrocarbons can then cause significant engine damage because they have not been adequately disintegrated, and have maintained destructive hardness. Thus, there is a need for a cleaning system which includes a method of removing this packed on soot without risking some of the cleaned particles being missed during the cleaning process and allowed to be reintroduced into the engine's combustion chambers where significant damage can occur.

### SUMMARY OF THE INVENTION

The present invention solves these needs existent in the prior art by creating a combination of devices and method for cleaning the air intake and EGR components in a diesel engine. It is one object of the present invention capable of causing a pressure drop in a chamber to create sufficient vacuum in a diesel air intake duct such that cleaner may be administered therein.

It is a second objective of the present invention to provide a plurality of swirler vanes which act on air being drawn into the air intake in such a way as to promote turbulence which will engage cleaner administered and make it more effectively contacted with contaminants existing within the air intake system.

It is a third object of the present invention to provide an auger for cleaning out the mouth of the air intake system upon which the EGR valve is usually situated in such a manner that contaminants are not allowed to crumble into the air intake system.

It is a fourth objective of the present invention to provide a chemical formulation which is particularly useful in cleaning diesel engines, and, more specifically the particular device disclosed herein.

### BRIEF DESCRIPTION OF THE SEVERAL VIEWS OF THE DRAWINGS

The present invention is described in detail below with reference to the attached drawing figures, wherein:

FIG. 1 is a view of an EGR-equipped air intake system with the EGR valve removed and the auger of the present invention in use cleaning contaminants off the inside surface of the air-intake duct.

FIG. 2 is a view of an air intake system where the EGR valve assembly has been removed and the vacuum control devices of the present invention have been installed thereon for cleaning purposes.

FIG. 3 is a control-cap-end view of the vacuum control device before it is installed on the air duct of the vehicle and wherein the swirler vanes are completely closed.

FIG. 4 is a break-out section 4-4 taken from FIG. 3.

FIG. 5 is a top view of the vacuum control device of the present invention.

FIG. 6 is a control-cap-end view of the vacuum control device wherein the swirler vanes are in substantially open position.

FIG. 7 is a backside view of the rotatable-control cap of the vacuum control device.

FIG. 8 is a control-cap-end view of the vacuum control device with the cap removed.

### DETAILED DESCRIPTION OF THE INVENTION

FIGS. 1-8 are illustrative of the present invention. FIG. 1 shows the typical air intake system of a diesel engine where the EGR valve has been removed. Normally, EGR valve 12 is attached to an air intake duct 14 by bolts 40 which are received through holes in flange 15. Air intake duct 14 is typically upstream of the combustion section (not pictured) of the diesel engine. In order that the present invention be implemented, EGR valve 12 is removed from air intake duct 14 by removing bolts 40.

Once removed, EGR valve 12 will be thoroughly cleaned manually (separately from the other processes described here) in a manner known to those skilled in the art. The EGR valve is then set aside, pending reattachment, as will be described later.

Air intake duct 14, the mouth thereof now exposed in the absence of EGR valve 12, will usually be visibly dirty. Especially if the vehicle has been driven for significant mileage. The technician will notice substantial build-up of hydrocarbons 7 on the cylindrical interior surface of air intake duct 14 proximate the mouth 42 of the air intake duct. This build-up poses many problems. The prior art method of cleaning this soot, was to either brush or chisel it away with hand-held tools. This technique, however, is risky. Risky because dislodged particles commonly become knocked into duct 14 and ultimately end up being drawn into the combustion section of the engine. Because they are very hard and relatively large with respect to what is acceptable in terms of impurities that can be tolerated by the combustion systems of the engine, significant engine damage is a possibility. To overcome this potential problem, an auger 30 is included in the present invention which is used to safely remove these deposits 19. Auger 30 comprises a helical flighting 32 which is disposed on a cylindrical longitudinal member 34 and a thumb activatable twisting cross-member 38. The outer diameter of the helical flighting 32 is substantially identical to the inside diameter of air intake duct 14. An insertion end 36 is located opposite the end having the thumb bar 38. Once EGR valve 12 has been removed from air intake conduit 14, insertion end 38 is then inserted into intake duct 40 for cleaning purposes. Because the flighting 32 at the insertion end 38 has been slightly tapered, its penetrability is enhanced. Twisting of thumb bar 38 in a clockwise direction will then screw auger 30 into air intake duct 14 much the same way a common screw is inserted into a drilled hole. Continued twisting once auger 30 is fully within duct 14 will cause the contaminates on the inside diameter of duct 14 to be withdrawn in a drilling fashion. This enables the inside surfaces of duct 14 to be substantially scraped clean without the risk of particles being dislodged only to fall deep into the air intake system and possibly causing engine damage.

Once duct 14 has been cleaned as so, it is time to begin the cleaning of the entire air intake system, as well as the combustion system, and exhaust system by administering cleaner. FIG. 2 shows the equipment that will be assembled to accomplish this objective. First, an adaptor 16 will be bolted onto the mouth 42 of air intake duct 14 in the same fashion as the EGR valve 12 would normally be attached. Onto adaptor 16, a vacuum control device 18 is attached. A cleaner is maintained in administrator 50 which is valved 27 and contains the cleaner. A preferred composition for this cleaner will be described hereinafter. The cleaner is allowed to flow from administrator 50 to a venturi nozzle 20 on vacuum control device 18 by way of a hose 52.

The details regarding adaptor 16 are disclosed in FIGS. 3, 4, and 5. Adaptor 16 has an outwardly extending cylindrical portion 115 and a flange 19. Cylindrical portion 115 and flange 19 together define a cylindrical opening 60 through adaptor 16. On flange 19, three holes 17 have been drilled which receive bolts 40 which are used to attach adaptor 16, as well as valve 12 to mouth 42 of duct 14 by passing bolts 40 through holes in flange 15 of air intake duct 14.

A threaded hole 117 is disposed radially through cylindrical portion 115 in order to receive a thumbscrew 21. Thumbscrew 21 is used to attach vacuum control device 18.

Vacuum-control device 18 is attached once adaptor 16 has been bolted onto mouth 42 of duct 14. The details of the vacuum control device 18 are shown in FIGS. 3-8. The outside diameter of an insertion end 25 of device 18 is infinitesimally smaller than the inside diameter of cylindrically extending portion 115 of adaptor 16. These dimensions allow end 25 to be slidably received inside opening 60 defined by adaptor 16 until the insertion end 25 reaches a ridge 70 created short of flange 19 within opening 60. Once end 25 has been abutted against ridge 70, device 18 is secured within adaptor 16 by screwing in thumbscrew 21. The tip of thumbscrew 21 engages a surface on the outside diameter of insertion end 25 of device 18. Device 18 is now securely held within adapter 16.

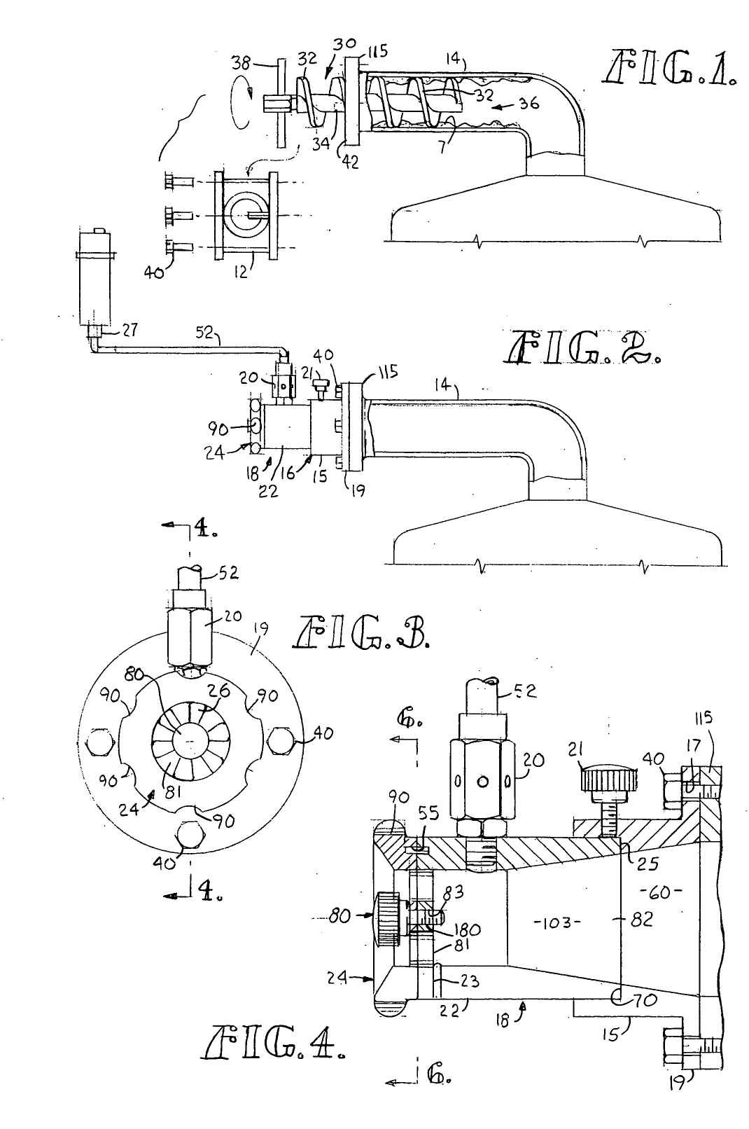

The functional features at the other end of device 18 will now be described. Evident from FIG. 4 is that device 18 is divided into two separate components. One is a cylindrical housing 22. The other is a vane control cap 24. Cap 24 and housing 22 work together to decrease the pressure in the housing 22 to create a vacuum within a chamber 103 defined by said housing. Cap 24 is fixed to housing 22 by a bolted knob 80. Housing 22 defines an opening 82 at insertion end 25, however, the other end is partially blocked off by a vaned wall 81. Wall 81 defines vanes 119 therein which allow the passage of air there-through. At the center of vaned wall 81, is a threaded receiving hole 83. This hole 83 receives the threaded bolt 180 of threaded bolted knob 80 to attach cap 24. Cap 24 has at its center a hole through which the bolt 180 from knob 80 is received. Thus, knob 80 holds cap 24 on housing 22.

Bored through the wall of forward end of and at the bottom of housing 22 is a drain hole 23. Drain 23 prevents the build up of too much fluid at the bottom of chamber 103. The buildup of too much fluid could cause hydrolocking of the engine. Drain 23 prevents this from happening.

Cap 24 has at its periphery a plurality of indentions 90 which may be engaged by the fingers of a user to make it easy to rotate cap 24 on housing 22 after it has been installed by knob 80.

Cap 24 also has on it a plurality of vanes 26 which reciprocate with the vanes 119 defined by wall 81 of housing 22 to create air-conducting apertures 121. Apertures 121 may be variably opened or shut as cap 24 is twisted relative to housing 22. In normal operation, vanes 26 on cap 24 will be slightly skewed relative to the vanes defined by wall 81 on housing as shown in FIG. 7. This skewing will create a medium flow through apertures 121. When cap 24 is in this skewed position, air is swirled when introduced into the housing 22 by vacuum from the combustion section of the engine, creating a swirling affect. The swirling affect, which is caused by the manner in which vanes 26 are offset relative to vanes 119, will create turbulence. Turbulence assists in forming cleaner administered into droplets which will affectively coat and remove contaminates from metal surfaces within the air intake system.

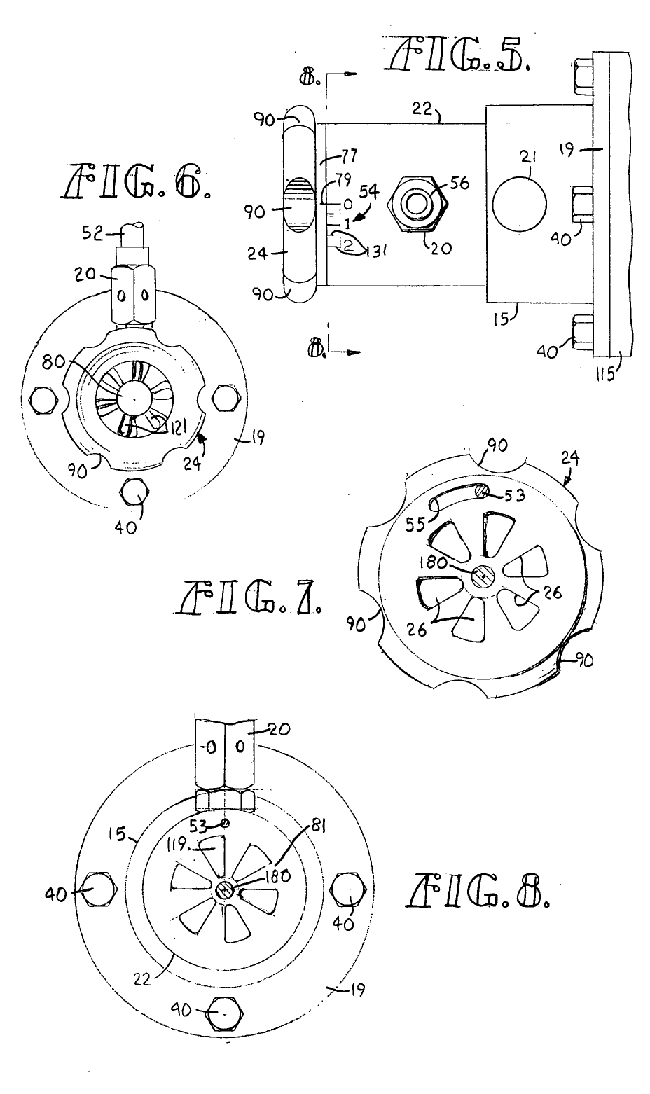

The vacuum control functions of device 18 will now be described in more detail. Knob 80 may be easily tightened or loosened so the vanes 26 on cap 24 may be easily rotated (slightly) and then locked into place by tightening. When vanes 26 on cap 24 are consonant with the vanes 119 on the wall 81 of the cylinder housing 22 the size of apertures 121 is at a maximum and thus, airflow will be allowed through apertures 121 is also maximized. This accordingly reduces the pressure in chamber 103 defined by the interior surfaces of housing 22 to create greater vacuum. If, however, the vanes on cap 22 are more skewed to the vanes on housing 22, as shown in FIG. 6, the apertures will be made smaller. Thus, less air will be permitted through the vanes, and the vacuum present within chamber 103 will be increased. The vanes may also be completely closed off, as shown in FIG. 3. This eliminates apertures 121, completely shutting off the draw of air, and maximizes the vacuum in chamber 103. By adjusting the skew of vanes 26 relative to vanes 119, the vacuum in housing 22 may be variably controlled.

Cap 24 is not allowed a complete range of rotational motion, however. Instead, it is limited within a specific angular range. Its rotation is limited using a pin/slot arrangement. A protruding pin 53 on the outside of wall 81 of housing 22 is received in a slot 55 (as can be seen in FIG. 7). Pin 53 is only allowed to slide within slot 55 until it reaches the ends of the slot. The ends of slot 55 are configured such that when pin engages one end of the slot, the vanes are completely open, and when pin 53 engages the opposite end of slot 55, the vanes are completely closed. At every pin position between the two slot ends, the apertures will be partially open. Thus, cap 24 is only allowed to rotate to the extent that the vanes defined by housing 22 may be completely closed, completely opened, or partially opened to some extent between these two extremes.

The present invention also includes an indicator dial for enabling the user to set the device for specific vacuum demands. An indicator mark 79 is formed on a smooth portion 77 of said cap which cooperates with a scale 54 notched in the exterior surface of the conical housing 22. Each of a plurality of notches 131 on scale 54 represent a different angular position of cap 24 relative to housing 22, and thus, the extent of openness with respect to apertures 121 created by vanes 26 on cap 24 and vanes 119 on the vacuum control device. For example, a value of “2” next to a notch might indicate that the apertures are completely open, whereas a value of zero might indicate complete closure. The size of the apertures is dependent on, and controllable by the position of mark 79 on the scale 54. The identification of a particular position is important to the invention, because adjustments must be made depending on the type of vehicle being serviced, because different vehicles have different vacuum requirements. The level will also be dependent on the elevation at which the vehicle is being serviced, because pressures at different elevations vary. The manufacturer may equip the user with tables that indicate the appropriate settings for a vehicle at a particular elevation.

In order to adjust the cap, the knob 80 is simply loosed in the cap 24 rotated until the desired position for indicator 79 is aligned with a particular notch on register 54. When the desired location is reached, the knob is simply tightened to lock the cap in the desired angular position such that the vanes are opened a desired amount.

In a typical application, cap 24 will be at a position that the vanes are only partially opened, rather than completely opened, and certainly not completely closed. Because the vanes on the housing 22 in such a position will be offset from those in cap 24 when the device is in normal operation, a swirl will be created within the housing 22 when a vehicle is being serviced. This swirl is used in the housing 22 to create turbulence which act to properly disperse cleaner introduced through venturi nozzle 20. The cleaner is drawn in through venturi nozzle 20 by the vacuum created within housing 22. The swirl created helps to deliver and diffuse cleaner droplets downstream to the soot-covered metal surfaces within air intake duct 14, the combustion chambers of the vehicle, and then out through the engines exhaust.

Once cleaning has been completed, vacuum control device 18 and adapter 16 are removed the air intake system 14. This is done by removing bolts 40 from the flange 15 surrounding the mouth 42 of duct 14. The EGR valve 12 is then rebolted to air intake duct 14 using the bolts.

Because the EGR valve 12 has been thoroughly cleaned manually (usually by soaking, scrubbing, scraping, etc.), and air-intake duct 14 has been cleaned by both auger 30 and the vacuum-controlled process described above, the entire system is completely cleaned and is ready to be returned to service, its operating condition being improved.

It has been determined that a particular cleaner is especially effective for use in the process described above. In a preferred embodiment, the cleaner comprises three separate components. The inclusion of each within the cleaner being optional.

The first component is a solvent which should be highly polar. It is a well-understood principle that highly polar solvents are ideal for cleaning contaminants of high polarity. The typical soot which accumulates on the air intake system and combustion chambers in the diesel vehicle tends to have extremely high polarity. Thus, a highly polar solvent is a good cleaner of such a contaminant. Alternatively, closely-related highly-polar solvents ethylene carbonate and butylene carbonate may be used in this process. Mixtures of propylene carbonate, ethylene carbonate and butylenes carbonate could also be used and still fall within the scope of the invention. The solvent used here in the preferred embodiment, however, is propylene carbonate (4-methyl-1,3-dioxolan-2-one) at 1 to 100 mass percent.

This highly polar solvent has proved to be outstanding not only because it is ideal for cleaning highly-polar contaminants, but also because of its combustibility properties. Propylene carbonate combusts well when run through a diesel system, unlike many other highly polar solvents. Not only does the propylene carbonate remove the deposits, but when used with the special equipment described in the application earlier, its chemistry will not significantly affect the combustion process. Another advantage is that propylene carbonate is relatively non-toxic and environmentally friendly.

Though propylene carbonate is used in this preferred embodiment, other highly polar solvents, however, could be used as the first component of the cleaner as well. The use of any other highly polar solvent could be used so long as it is reasonably accepted by the diesel combustion in the vehicle engine. Thus, other highly-polar solvents could be used as the first component and still fall within the scope of the present invention.

In the cleaner of the preferred embodiment, a second component is also included. The second component of the cleaner is a solvent, like the first. Unlike the first component, however, the solvent of the second component is one of relatively low polarity. The low-polarity solvent is added to the cleaner to more adequately dissolve low-end hydrocarbons present in the air intake system and combustion chamber. Aside from the extremely hard highly-polar contaminants clinging to the metal surfaces within the air intake and combustion systems, low-end hydrocarbons, such as oils and diesel fuels, are also re-circulated along with the exhaust in an EGR system. It is well known in the art that these low-end hydrocarbons are more easily removed with a low-polarity solvent. One example of a solvent that could be used effectively for such purposes is an aeromatic solvent. Some examples of aeromatic solvents that may be used effectively would be toluene, zylenes, cumenes, or any other low-polarity solvent that would not significantly impede the diesel combustion process. It is preferable that an aeromatic solvent be used that has a boiling range between 200 to 700 degrees Fahrenheit.

Surfactants and/or dispersants may also optionally added as a third component to the formulation in order to enhance the cleaning of the harder baked-on deposits found on intake valves in the lower section of the air plenum as it meets the engine head. Because of the polar nature of propylene carbonate, ionic-type surfactants such as amines neutralized alkylbenzene sulfonic acid such as dodecylbenzene sulfonic acid or an amine neutralized organic acids such as oleic acid may be added as a third component.

The percentage by volume of propylene carbonate used within the formulation, preferably ranges from 20 to 80 percent of the overall volume. In an even more preferred embodiment, propylene carbonate would comprise about 70 percent of the overall formulation. In this more preferred embodiment, the second low-polarity solvent would comprise approximately 30 percent of the formulation.

When a surfactant is included within the cleaner, a moderate amount would likely be used, which would slightly reduce the relative values (by volume percentage) of the low-polarity solvent and highly polar solvent.

It is important to note that, though first, second, and third components (two solvents and one surfactant) have been included in the preferred formulation here, only one of the two solvents could be administered according to the claimed process and still fall within the scope of this invention. Further, the first and second cleaners could both be administered at separate times and still fall within the scope of this invention. As already stated above, the use of surfactant is entirely optional.

Although the invention has been described with reference to the preferred embodiments illustrated in the attached, and described in the above description, one skilled in the art will recognize that numerous substitutions could be made and the equivalents employed herein without departing from the scope of the invention, which is more properly defined as it is recited in the claims which, of course, are subject to amendment.

The invention claimed is:

1. A device for use in cleaning the air intake system of an engine comprising:
a controller connected with the air intake system for dropping pressures in said air intake system;
a source of cleaner with means to introduce said cleaner into said air intake system and may be induced into said air intake system by the pressure drop created by the controller.

2. The device of claim 1 in which said controller further comprises:
at least one aperture sizeable to create an appropriate reduction in pressure in said air intake system.

3. The device of claim 2 in which said controller further comprises:
a vessel connected to a mouth of the air intake system;
said vessel having a chamber defined therein; and
said chamber being substantially air-tight, except for said at least one aperture.

4. The device of claim 3 wherein said at least one sizeable aperture comprises:
a first member defined by said vessel having a first hole therein; and
a second member attached to said vessel having a second hole therein;
said first and second members being slideable, one on top of the other such that the first hole may be slid so as to be partially offset relative to said second hole to size said at least one aperture.

5. The device of claim 4 wherein each of said first and second holes are substantially elliptical.

6. The device of claim 4 wherein said second member is rotatable on said first member.

7. The device of claim 6 wherein rotation of said second member on said first member is limited between two extreme positions by a pin on one of said first and second members and a slot on the other of said first and second members.

8. The device of claim 6 wherein an indicator is provided for use in informing the user of the angular position of said second member relative to said first member, said indicator comprising:
a mark on the periphery of one of said first and second members and a scale on the other of said first and second members.

9. The device of claim 4 wherein when said first and second holes are offset, a swirling effect is caused in said chamber.

10. The device of claim 3 wherein said means to introduce said cleaner comprises:
a container for holding said cleaner;
a conduit with first and second ends said first end fluidly connected to said container; and
a nozzle on said second end of said conduit incorporated into a portion of said vessel for introducing the cleaner into the chamber.

11. A method of cleaning the air intake system of an engine, said engine having an air intake system, said system having a duct, said duct having a mouth, and an EGR valve removeably connected to said mouth of said air intake duct, said method comprising the steps of:
removing the EGR valve;
providing a cleaner source;
suctioning said cleaner from said source into said air intake system by lowering the pressure in the air intake duct to lower levels than occur with the engine under normal operating conditions.

12. The method of claim 11 wherein said lowering of pressure step further comprises:
providing a vacuum control vessel;
attaching said vessel to the mouth in place of said EGR valve;
providing at least one sizeable aperture on said vessel; and
manipulating the size of said at least one sizeable aperture to lower the pressure within said vessel to a level which creates a desired amount of suction.

13. The method of claim 11, including the additional steps of:
providing an auger; and
augering out the inside surfaces of said duct proximate the mouth of the duct after said removing step and before said suctioning step for the purpose of removing contaminants.

14. The method of claim 11, wherein said step of providing said cleaner source comprises the steps of:
introducing a highly-polar first solvent; and
mixing the highly-polar first solvent with a second solvent of low polarity.

15. A cleaner for use in cleaning at least one engine system of a diesel engine, said cleaner comprising:
a first component which is a highly-polar solvent for cleaning high end hydrocarbons; and
a second component which is a solvent having low polarity for cleaning low-end hydrocarbons.

16. The cleaner of claim 15 comprising:
a third component which is a surfactant.

17. A cleaner for use in cleaning at least one engine system of a diesel engine, said cleaner comprising:
a highly polar solvent, said solvent being reasonably accepted by said diesel engine during the combustion process.

18. The cleaner of claim 17 in which said solvent comprises:
propylene carbonate.

19. The cleaner of claim 17 comprising:
a solvent having low polarity for cleaning low-end hydrocarbons.

20. The cleaner of claim 19 wherein said solvent having low polarity is an aeromatic solvent.

21. The cleaner of claim 20 wherein said aeromatic solvent is one of toluenes, zylenes, and cumenes or any combination thereof.

22. The cleaner of claim 17, wherein said highly polar solvent is one of ethylene carbonate, butylene carbonate, propylene carbonate or any combination thereof.

23. An auger used to clean the inside surface of the air-intake duct of an engine, said duct having a mouth, a portion of said duct proximate said mouth having a substantially cylindrical inside surface, comprising:
a longitudinal member supporting a helical flighting, said flighting having an outside diameter infinitesimally smaller than the inside diameter of said portion.
